(19) United States
(12) Patent Application Publication
(10) Pub. No.: US 2014/0306920 A1
(43) Pub. Date: Oct. 16, 2014

(54) TOUCH SCREEN STRUCTURE FOR RECEIVING AND PROCESSING TOUCH SIGNAL

(71) Applicant: HIMAX TECHNOLOGIES LIMITED, Tainan City (TW)

(72) Inventors: Jui-Ni LEE, Tainan City (TW); Sheng-Fan YANG, Tainan City (TW); Yaw-Guang CHANG, Tainan City (TW); Shen-Feng TAI, Tainan City (TW); Cheng-Feng HSIEH, Tainan City (TW)

(73) Assignee: Himax Technologies Limited, Tainan City (TW)

(21) Appl. No.: 13/859,868

(22) Filed: Apr. 10, 2013

(51) Int. Cl. G06F 3/044

(52) U.S. Cl. CPC G06F 3/044
USPC 345/174

(57) ABSTRACT

A touch screen structure for receiving and processing touch signal is disclosed, in which the touch screen structure includes a substrate, a plurality of conductive patterns, a plurality of first routing traces, and a plurality of second routing traces. The conductive patterns are disposed on the substrate, in which each of the conductive patterns has a first side and a second side disposed opposite to the first side. The first routing traces are disposed on the substrate, in which the first routing traces are electrically connected to the first sides of the conductive patterns. The second routing traces are disposed on the substrate, in which the second routing traces are electrically connected to the second sides of the conductive patterns.

### BACKGROUND

1. Field of Invention

The present invention relates to a touch screen. More particularly, the present invention relates to a touch screen having ITO patterns.

2. Description of Related Art

A touch screen panel is an input device that a user can input his or her instruction by selecting an instructed content displayed on a screen of such as an image display device. Users are enabled to give instructions to a host through touching the touch screen panel with their fingers or objects.

To this end, the touch screen panel is usually provided on the front face of the image display device to convert a contact position of the user's finger or an object into an electrical signal. Therefore, the instructed content displayed and selected on the contact position is accepted as an input information. The touch screen panel accordingly can replace a conventional input device, e.g., a keyboard, a mouse, or the like, and be integrated into the image display device in operation, so as to achieve a wide variety of applications.

There are three types: a resistive type, a photosensitive type, and an electrostatic capacity type, known to implement the touch sensing device in the touch screen panel. A certain type of the touch screen panel usually includes conductive sensing patterns to sense capacitance changes caused in association with other sensing patterns, thereby converting a contact position into an electrical signal.

In order to clearly determine the contact position on the on the front face of the image display device, the sensing patterns are usually divided into different groups along different directions. Further, those sensing patterns as described above are generally positioned in the same layers.

However, the routing traces which are connected to the sensing patterns for passing touch signals might have coupling problem of causing the abnormal latch point. In normal condition, the touched region has a higher IR value while the non-touched region has a low IR value that should be as small as zero.

Nevertheless, the non-touch region might irregularly have a high IR value when the routing traces have the coupling problem, and the abnormal latch point occurs accordingly. As a result, the contact position is erroneously estimated along with the incorrect input information.

### SUMMARY

According to one embodiment of the present invention, a touch screen structure for receiving and processing a touch signal is disclosed, in which the touch screen structure includes a substrate, a plurality of conductive patterns, a plurality of first routing traces, and a plurality of second routing traces. The conductive patterns are disposed on the substrate, in which each of the conductive patterns has a first side and a second side disposed opposite to the first side. The first routing traces are disposed on the substrate, in which the first routing traces are electrically connected to the first sides of the conductive patterns. The second routing traces are disposed on the substrate, in which the second routing traces are electrically connected to the second sides of conductive patterns.

According to another embodiment of the present invention, a touch screen structure for receiving and processing a touch signal is disclosed, in which the touch screen structure includes a substrate, a plurality of conductive patterns, a plurality of first routing traces, and a plurality of second routing traces. The conductive patterns have a plurality of contact terminals disposed on the substrate, in which the conductive patterns are divided into an odd group and an even group according to their arranged sequence, and the conductive patterns of the odd group are interleaved by the conductive patterns of the even group. The first routing traces are disposed on the substrate, in which the first routing traces are electrically connected to the contact terminals toward a first direction. The second routing traces are disposed on the substrate, in which the second routing traces are electrically connected to the contact terminals toward a second direction.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of a touch screen structure according to one embodiment of the present invention;

FIG. 2 is a plan view of a touch screen structure according to another embodiment of the present invention; and

FIG. 3 is a capacitance chart which shows the capacitance characteristic of the conventional one and the embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The touch screen structures of the following embodiments disperse the routing traces into two groups disposed in different regions of the substrate such that the routing traces are not as concentrated as the conventional ones, and the routing traces coupling problem can be relieved.

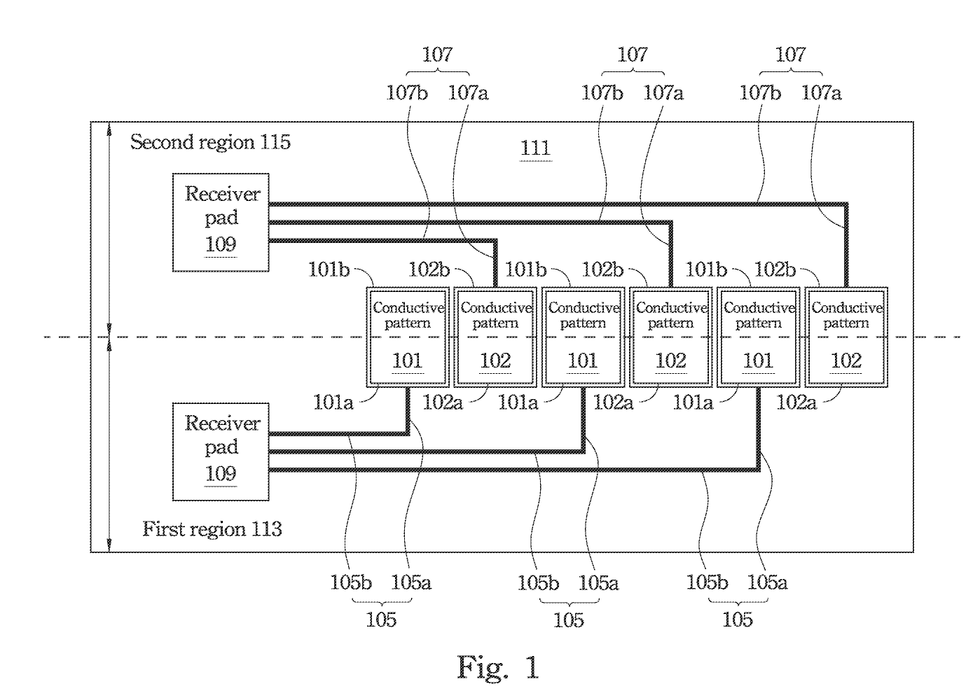

FIG. 1 is a block diagram of a touch screen structure according to one embodiment of the present invention. The touch screen structure is used to receive and process a touch signal, in which the touch screen structure includes a substrate 111, a plenty of conductive patterns 101/102, a plenty of first routing traces 105, and a plenty of second routing traces 107.

The conductive patterns 101/102 are disposed on the substrate 111, in which each of the conductive patterns 101/102 has a first side 101a/102a and a second side 101b/102b disposed opposite to the first side 101a/102a. Specifically, the conductive patterns 101 have the first sides 101a and the second sides 101b while the conductive patterns 102 have the first sides 102a and the second sides 102b. Those conductive patterns 101/102 can be square. The conductive patterns 101/102 are divided into an odd group (the conductive patterns 101) and an even group (the conductive patterns 102) according to their arranged sequence, and the conductive patterns 101 of the odd group are interleaved by the conductive patterns 102 of the even group.

The first routing traces 105 and the second routing traces 107 are receiver type traces which pass received touch signal. The first routing traces 105 disposed on the substrate 111 are electrically connected to the first sides 101a of the conductive patterns 101. The second routing traces 107 disposed on the substrate 111 are electrically connected to the second sides 102b of conductive patterns 102. The first routing traces 105 and the second routing traces 107 are disposed in different regions which are interleaved by the conductive patterns 101/102.

Particularly, the first routing traces 105 are connected to the conductive patterns 101 of the odd group while the second routing traces 107 are connected to the conductive patterns 102 of the even group. Therefore, the first routing traces 105 are disposed in the first region 113, and the second routing traces 107 are disposed in the second region 115. With such fan-out routing method, the routing traces 105/107 are dispersed and are not that concentrated such that the coupling problem is relieved.

Each of the first routing traces 105 includes a first segment 105a connected to the first side 101a of one of the conductive patterns 101 and includes a second segment 105b substantially perpendicular to the first segment 105a. Similarly, each of the second routing traces 107 includes a first segment 107a connected to the second side 102b of one of the conductive patterns 102 and includes a second segment 107b substantially perpendicular to the first segment 107a.

The touch screen structure further includes a plenty of receiver pads 109. Those receiver pads 109 are connected to the first routing traces 105 and the second routing traces 107 for collecting and transferring the received touch signal. These receiver pads 109 can be made of conductive material, such as indium tin oxide (ITO). Similarly, any one or all of the conductive patterns 101/102, the first routing traces 105, and the second routing traces 107 can also be made of indium tin oxide

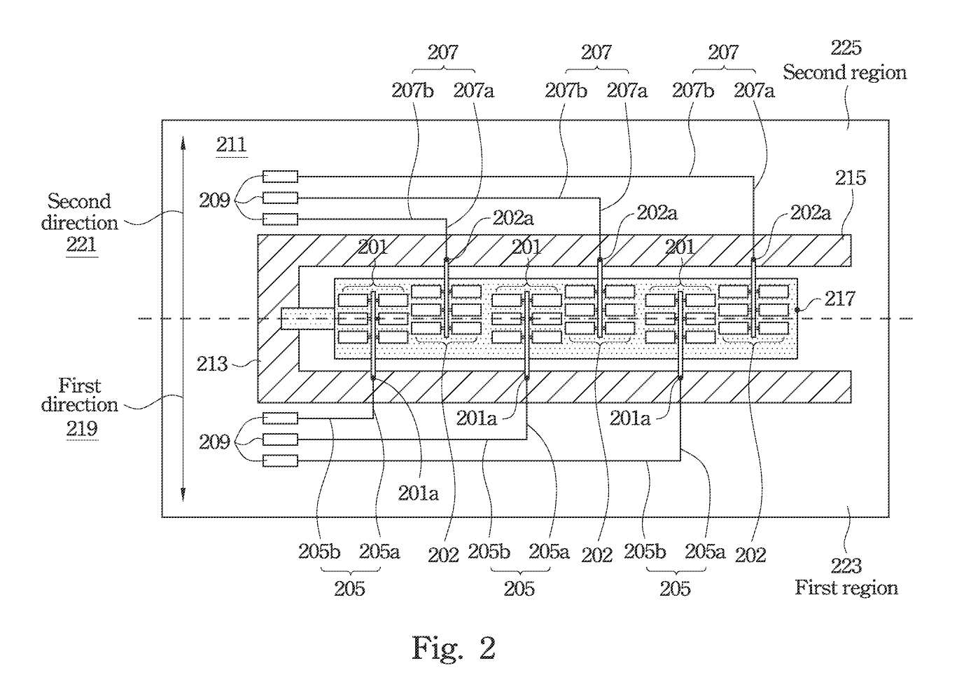

FIG. 2 is a plan view of a touch screen structure according to another embodiment of the present invention. The touch screen structure is used to receive and process a touch signal, in which the touch screen structure includes a substrate 211, a plenty of conductive patterns 201/202, a plenty of first routing traces 205, and a plenty of second routing traces 207. The conductive patterns 201/202, the first routing traces 205, and the second routing traces 207 can be made of indium tin oxide.

The conductive patterns 201/202, divided into an odd group (conductive patterns 201) and an even group (conductive patterns 202) according to their arranged sequence, have a plenty of contact terminals 201a/202a disposed on the substrate 211, in which the conductive patterns 201 of the odd group are interleaved by the conductive patterns 202 of the even group. Furthermore, the contact terminal 201a of the conductive patterns 201 belong to the odd group extends toward a first direction 219 while the contact terminal 202a of the conductive pattern 202 belong to the even group extends toward a second direction 221. In particularly, the first direction 219 and the second direction 221 are opposite.

The first routing traces 205 are disposed on the substrate 211, in which the first routing traces 205 are electrically connected to the contact terminals 201a toward a first direction 219. The second routing traces 207 are disposed on the substrate 211, in which the second routing traces 207 are electrically connected to the contact terminals 202a toward the second direction 221. Therefore, the first routing traces 205 and the second routing traces 207 are disposed in different regions (the first region 223 and the second region 225) which are interleaved by the conductive patterns 201/202. With such routing traces configuration, the routing traces are dispersed into two groups and are not that concentrated as the conventional one, and space between the routing traces are enlarged. As a result, the coupling problem between the adjacent traces is relieved.

The first routing traces 205 and the second routing traces 207 includes a plenty of first segments 205a/207a connected to the contact terminals 201a/202a of the conductive patterns 201/202. The first routing traces 205 and the second routing traces 207 also include a plenty of second segments 205b/207b substantially perpendicular to the first segments 205a/207a. These routing traces 205/207 are receiver type traces which pass the touch signal received.

The touch screen structure further includes a transmitter type trace (not shown) and a plenty of receiver pads 209 disposed on the substrate 211, in which the transmitter type trace and the receiver type traces 205/207 are disposed on same one layer, and the receiver pads 209 are connected to the first routing traces 205 and the second routing traces 207.

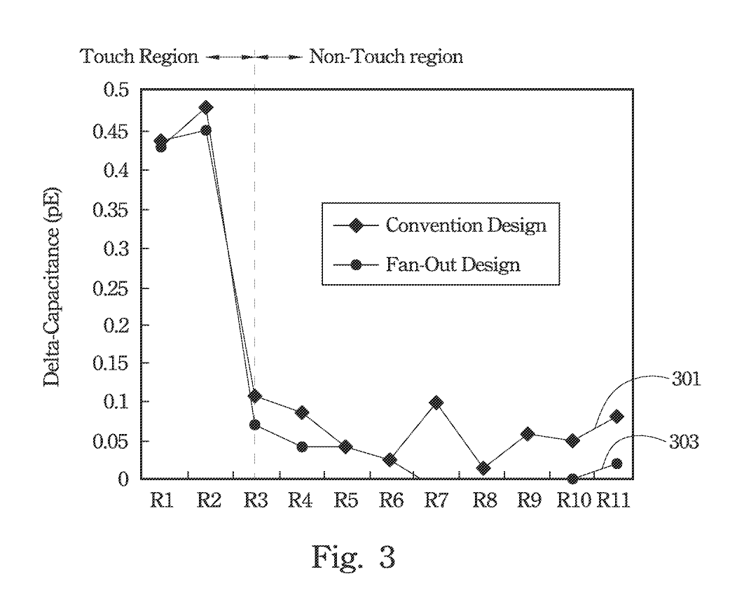

FIG. 3 is a capacitance chart which shows the capacitance characteristic of the conventional one and one embodiment of the present invention. As shown in FIG. 3, the capacitance value 301 of the conventional touch panel structure is still high in the non-touched region, which is the source to cause the abnormal latch point. On the other hand, the capacitance value 303 of the touch panel structure according to one embodiment of the present invention is almost equal to zero in the non-touch region, which relives the abnormal latch point problem.

The touch screen structure of the above embodiments makes the routing traces disperse into two groups, and space between the routing traces are enlarged. As a result, the coupling problem caused between the adjacent traces is relieved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A touch screen structure for receiving and processing a touch signal, the touch screen structure comprising:
a substrate;
a plurality of conductive patterns disposed on the substrate, wherein each of the conductive patterns has a first side and a second side disposed opposite to the first side;
a plurality of first routing traces disposed on the substrate, wherein the first routing traces are electrically connected to the first sides of the conductive patterns; and
a plurality of second routing traces disposed on the substrate, wherein the second routing traces are electrically connected to the second sides of conductive patterns.

2. The touch screen structure as claimed in claim 1, wherein the conductive patterns are square.

3. The touch screen structure as claimed in claim 1, wherein the conductive patterns are divided into an odd group and an even group according to their arranged sequence, and the conductive patterns of the odd group are interleaved by the conductive patterns of the even group.

4. The touch screen structure as claimed in claim 3, wherein the first routing traces are connected to the conductive patterns of the odd group while the second routing traces are connected to the conductive patterns of the even group.

5. The touch screen structure as claimed in claim 1, wherein the first routing traces and the second routing traces are disposed in different regions which are interleaved by the conductive patterns.

6. The touch screen structure as claimed in claim 1, wherein the first routing traces and the second routing traces comprise:
a plurality of first segments connected to the first sides or the second sides of the conductive patterns; and
a plurality of second segments substantially perpendicular to the first segments.

7. The touch screen structure as claimed in claim 1, wherein the first routing traces and the second routing traces are receiver type traces which pass received touch signal.

8. The touch screen structure as claimed in claim 1, further comprising:
a plurality of receiver pads connected to the first routing traces and the second routing traces.

9. The touch screen structure as claimed in claim 1, wherein at least one of the conductive patterns, the first routing traces, and the second routing traces is made of indium tin oxide.

10. A touch screen structure for receiving and processing a touch signal, the touch screen structure comprising:
a substrate;
a plurality of conductive patterns having a plurality of contact terminals disposed on the substrate, wherein the conductive patterns are divided into an odd group and an even group according to their arranged sequence, and the conductive patterns of the odd group are interleaved by the conductive patterns of the even group.;
a plurality of first routing traces disposed on the substrate, wherein the first routing traces are electrically connected to the contact terminals toward a first direction; and
a plurality of second routing traces disposed on the substrate, wherein the second routing traces are electrically connected to the contact terminals toward a second direction.

11. The touch screen structure as claimed in claim 10, wherein the first routing traces and the second routing traces are disposed in different regions which are interleaved by the conductive patterns.

12. The touch screen structure as claimed in claim 10, wherein the first routing traces and the second routing traces comprise:
a plurality of first segments connected to the contact terminals of the conductive patterns; and
a plurality of second segments substantially perpendicular to the first segments.

13. The touch screen structure as claimed in claim 10, wherein the first routing traces and the second routing traces are receiver type traces which pass the touch signal received.

14. The touch screen structure as claimed in claim 10, further comprising:
a plurality of receiver pads connected to the first routing traces and the second routing traces.

15. The touch screen structure as claimed in claim 10, wherein at least one of the conductive patterns, the first routing traces, and the second routing traces are made of indium tin oxide.
